(19) United States
(12) Patent Application Publication
(10) Pub. No.: US 2009/0301268 A1
(43) Pub. Date: Dec. 10, 2009

(54) Ratchet mechanism for adjustable wrench

(75) Inventor: Arthur Wu, Taichung County (TW)

Correspondence Address: Arthur Wu, P.O. Box 44-2049, Taipei, 10668, TW

(73) Assignee: Proxene Tools Co., Ltd.

(21) Appl. No.: 12/155,406

(22) Filed: Jun. 4, 2008

(51) Int. Cl. B25B 13/46; B25B 13/12

(52) U.S. Cl. 81/63.1; 81/165

(57) ABSTRACT

An adjustable wrench includes a fixed jaw and a movable jaw movable along a slot in the head. A passage is defined through the head and communicates with the slot. Two rack portions are defined in the guide rod. Two pawls are movably engaged with the passage and each pawl has teeth and the two pawls are alternatively engaged with the two rack portions. Two respective positioning units are located between the two pawls and an inside of the passage so as to position the pawls to be engaged with the pawls or separated from the pawls. The two rack portions are made by Metric system and English system respectively.

### BACKGROUND OF THE INVENTION

(1) Field of the Invention

The present invention relates to a ratchet mechanism for an adjustable wrench and includes two pawls with different pitches so as to control the movable jaw by different pitches.

(2) Description of the Prior Art

A conventional adjustable wrench is disclosed in U.S. Pat. No. 1,523,093 which discloses a ratchet mechanism for controlling the movable jaw and the ratchet mechanism includes two pawls which are located alternatively to each other and only one of the pawls is engaged with the rack portion of the guide rod of the movable jaw. By this arrangement, the movable jaw can be adjusted by small distance relative to the fixed jaw.

However, there is only one rack portion defined in the guide rod so that the wrench can only be used to tighten or loosen the workpiece of Metric system or English system. The users have to prepare two wrenches with the two different systems to deal with the workpieces of different systems.

Applicant has filed a patent application with application Ser. No. 10/987591 which provides two rack portions on the guide rod of the movable jaw and the two rack portions are made by Metric system and English system so as to improve the shortcomings of the conventional adjustable wrenches.

The present invention intends to provide a ratchet mechanism for controlling two pawls of different systems to optionally engaged with the desired rack portion on the guide rod of the movable jaw.

### SUMMARY OF THE INVENTION

The present invention relates to an adjustable wrench that comprises a handle with a head connected to an end thereof and a fixed jaw is connected to a top of the head. A slot defined in the top of the head and a passage is defined through the head and communicates with the slot. A movable jaw has a guide rod and two rack portions are defined in the guide rod. The guide rod is slidably engaged with the slot. Two pawls are movably engaged with the passage and each pawl has teeth defined in a top surface thereof. The teeth of the two pawls are alternatively engaged with the two rack portions. Two respective positioning units are located between the two pawls and an inside of the passage so as to position the pawls to be engaged with the pawls or separated from the pawls.

The primary object of the present invention is to provide a ratchet mechanism for an adjustable wrench and the two pawls of the ratchet mechanism are optionally engaged with two rack portions of the movable jaw respectively. The two rack portions and the teeth of the two pawls are made by Metric system and English system respectively.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the adjustable wrench of the present invention;

FIG. 2 is a perspective view to show the adjustable wrench of the present invention;

FIG. 3 is a partial cross sectional view of the ratchet mechanism in the adjustable wrench of the present invention;

FIG. 4 is a side cross sectional view of the ratchet mechanism in the adjustable wrench of the present invention;

FIG. 5 is a partial cross sectional view to show that one of the two pawls of the ratchet mechanism is disengaged from the rack portion of the movable jaw of the adjustable wrench of the present invention;

FIG. 5A shows one of the operation pads is moved downward to release position;

FIG. 6 a side cross sectional view to show the status in FIG. 5;

FIG. 7 is an exploded view to show another embodiment of the adjustable wrench of the present invention, and

FIGS. 8 and 9 show that the two pawls are disengaged from the rack portions respectively.

### DETAILED DESCRIPTION OF THE PREFERRED EMBODIMENTS

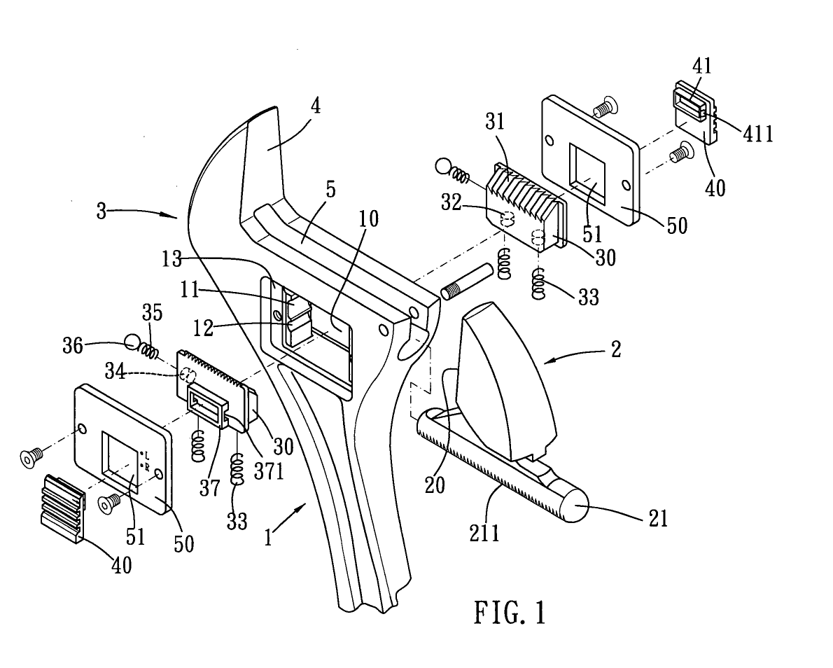

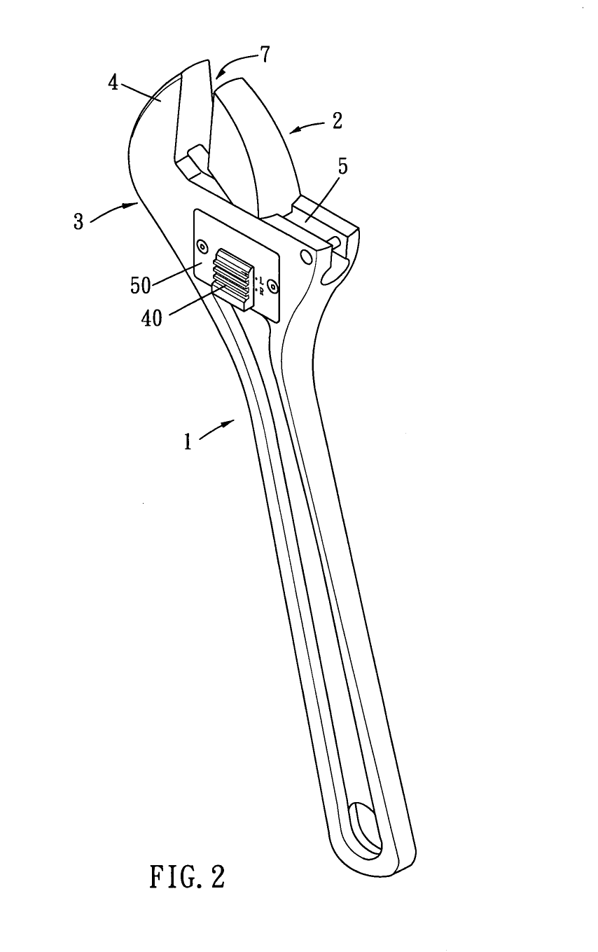

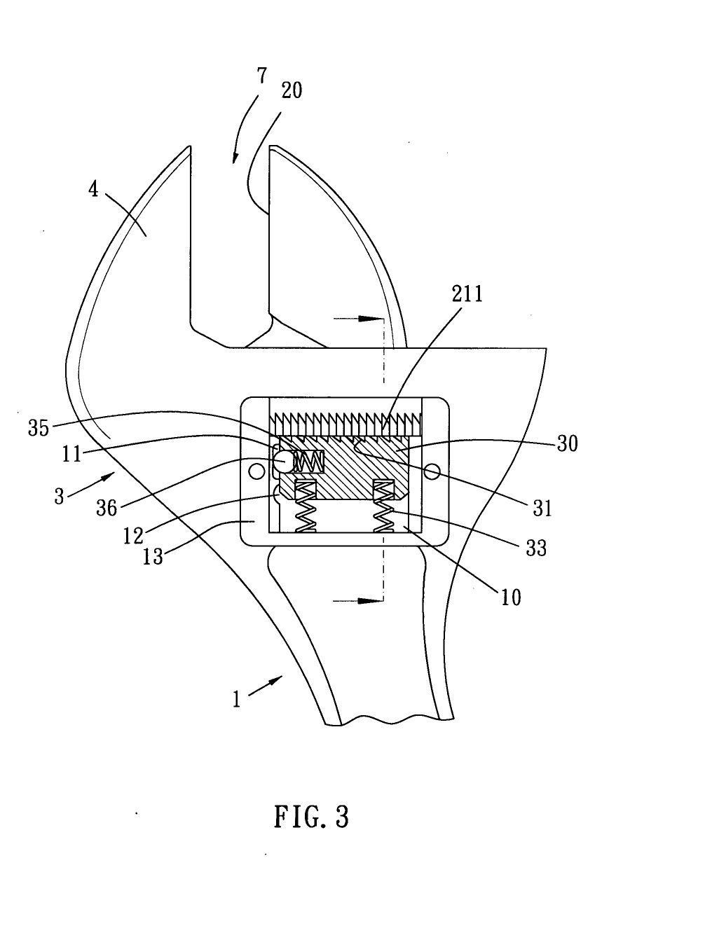

Referring to FIGS. 1 to 4, the adjustable wrench of the present invention comprises a handle 1 with a head 3 connected to an end thereof and a fixed jaw 4 is connected to a top of the head 3. A slot 5 is defined in the top of the head 3 and opens to an end of the head 3. A rectangular passage 10 is defined through the head 3 and communicates with the slot 5. A movable jaw 3 has a clamp surface 20 and a guide rod 21 is connected to a bottom of the movable jaw 3. Two rack portions 211 are defined in a lower portion of the guide rod 21 and the guide rod 21 is slidably engaged with the slot 5 via the opening in the end of the head 3. The two rack portions 211 are made by Metric system and English system respectively.

Two pawls 30 are movably engaged with the passage 10 and located on two sides of the head 3. Each pawl 30 has teeth 31 defined in a top surface thereof and the teeth 31 of the two pawls 30 are alternatively engaged with the two rack portions 211 when operating the wrench. 6. Each of the pawls 30 has two bottom holes 32 defined in the underside thereof so as to receive two respective ends of two springs 33. The other ends of the two springs 33 are in contact with an inside of the passage 10, such that the springs 33 bias the pawl 30 upward so that the teeth 31 of the two pawls 30 are engaged with the two rack portions 211 when the wrench is not yet operated.

Two respective positioning units are located between the two pawls 30 and another inside of the passage 10. A first groove 11 and a second groove 12 are defined in the inside of the passage 10 and the positioning units are engaged with one of the first and second grooves 11, 12. In detail, each of the pawls 30 includes a side hole 34 and the two positioning units each comprise a spring 35 and a bead 36 which is biased by the spring 35 which is engaged with the side hole 34, the bead 36 is optionally engaged with one of the first and second grooves 11, 12. It is noted that the first groove 11 has a distance extending in axial direction of the head 3 and the beads 36 can be movable within the distance when the movable jaw 2 moves along the slot 5.

Two respective operation pads 40 are connected to the two pawls 30 and located on two sides of the head 30. Two respective covers 50 are located between the pawls 30 and the operation pads 40, each cover 50 has a guide hole 51 defined therethrough. The two covers 50 are engaged with two recessed areas 13 defined in the two sides of the head 3. A retaining frame 37 is connected to each pawl 30 and an insertion 41 is connected to each operation pad 40. Each of the retaining frames 37 has a notch 371 and each of the insertion 41 has a catch 41 which is engaged with the notch 371 when combining the pawl 30 and the operation pad 40. The retaining frame 37 and the insertion 41 are movable within the guide hole 51.

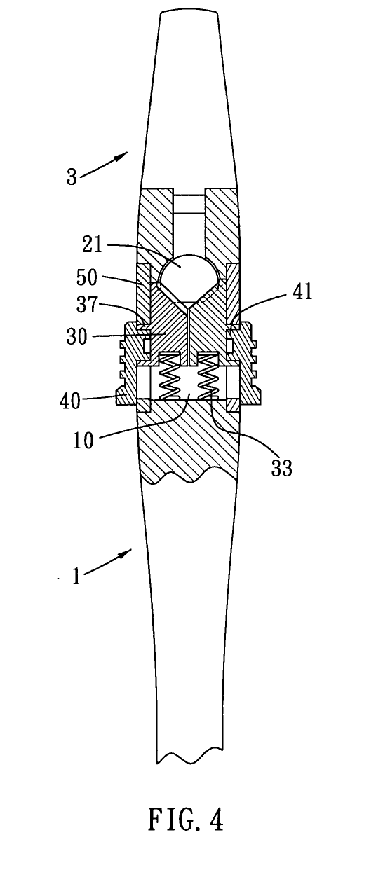

As shown in FIG. 4, when the wrench is not operated, the two pawls 30 are pushed by the springs 33 and the teeth 31 of the tow pawls 30 are engaged with the rack portions 211.

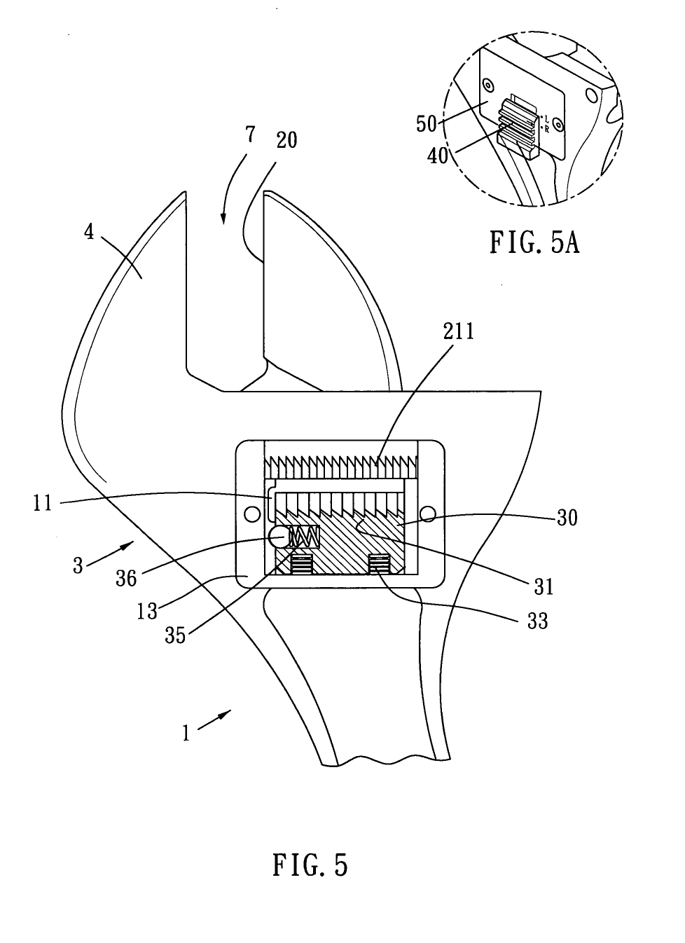

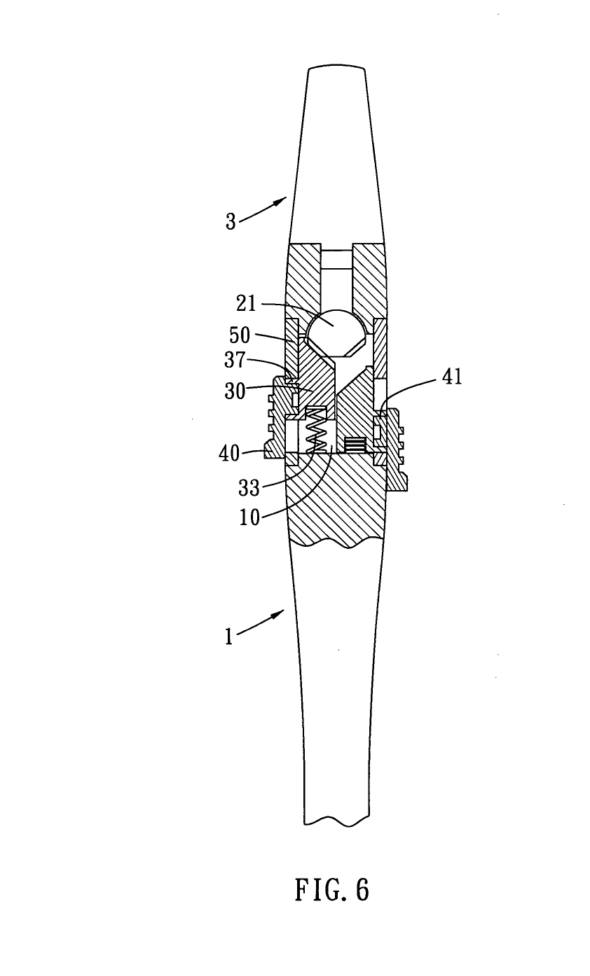

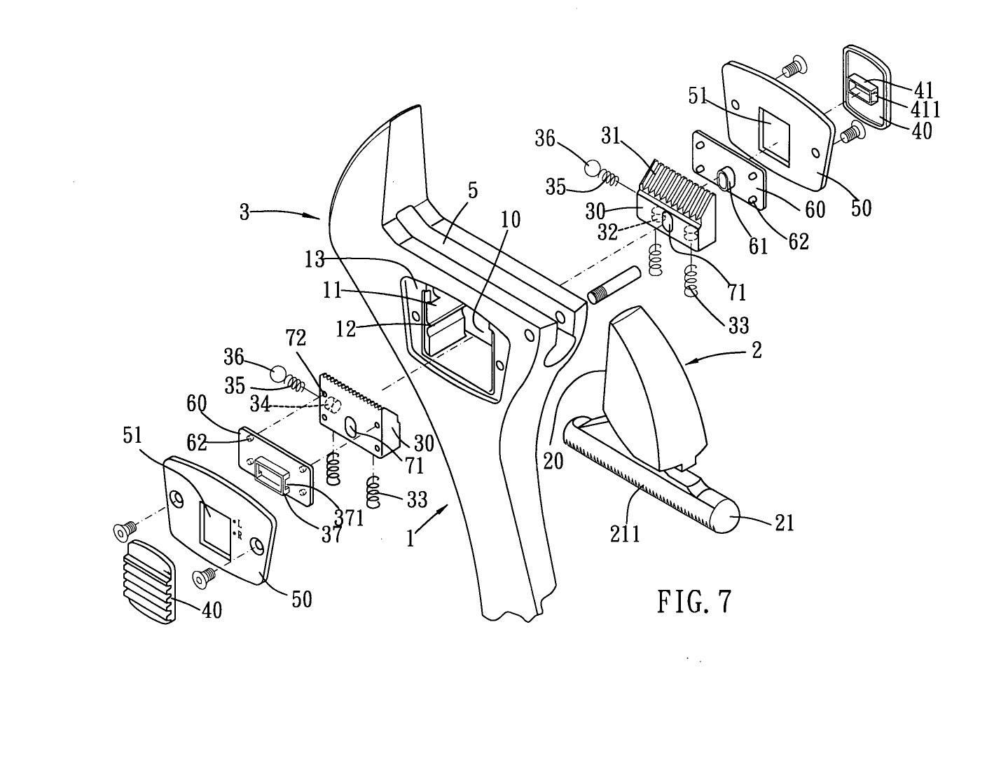

As shown in FIGS. 5, 5A and 6, when using the wrench, one of the operation pads 40 is pulled downward from position locked (L) to position released (R). The pulled pawl 30 is disengaged from the rack portion 211 corresponding thereto. Therefore, the movable jaw 2 can be adjusted relative to the fixed jaw 4 by Metric system or by English system depends on which pawl 30 is engaged with the rack portion 211. The bead 36 cooperated with the pawl 30 that is pulled down is moved from the first groove 11 to the second groove 12 which is narrower than that of the first groove 11 so as to position the bead 36. When adjusting the movable jaw 2, the rack portion 211 move over the teeth of the pawl 30 so that the pawl 30 is moved up and down but do not stop the movement of the movable jaw 2 when moving the movable jaw 2 toward the fixed jaw 4.

By using the two pawls 30 to engage with the rack portions 211 corresponding thereto, the user can choose Metric system or English system conveniently to clamp a workpiece (not shown) in the space 7 (FIG. 5) between the fixed jaw 4 and the movable jaw 3.

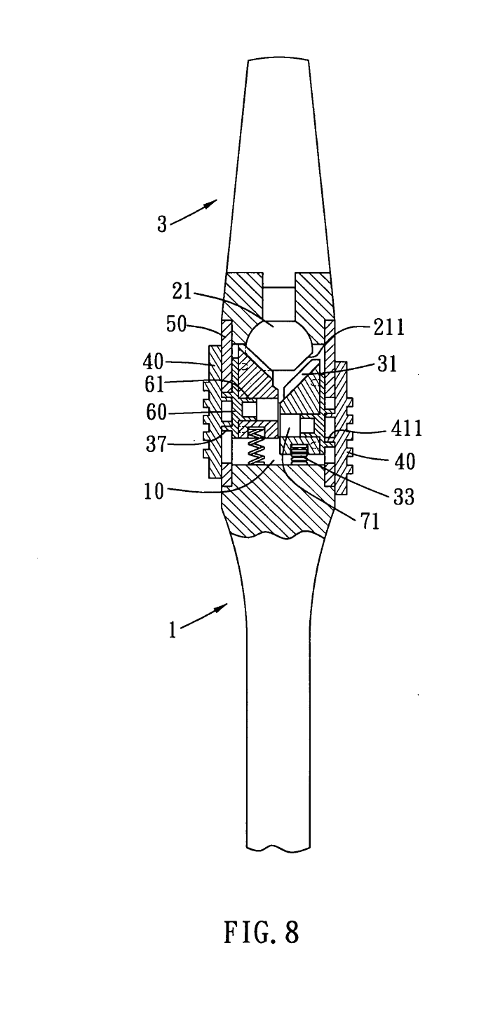

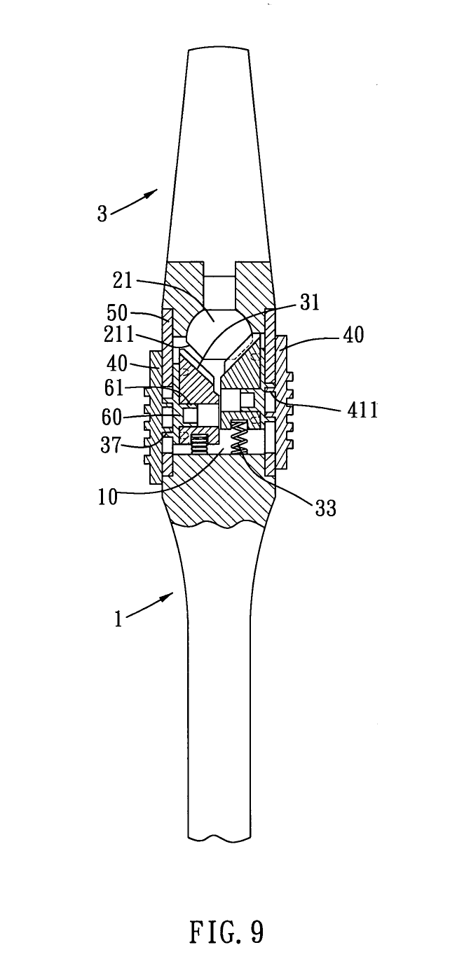

FIGS. 7 to 9 show another embodiment of the present invention, wherein each of the retaining frames 37 is connected to one of two plates 60 and each plate 60 has four protrusions 62 and one oval rod 61. Each of the pawls 30 has four oval holes 71 with which the protrusions 62 are engaged, and one oval hole 71 with which the oval rod 61 is engaged.

While we have shown and described the embodiment in accordance with the present invention, it should be clear to those skilled in the art that further embodiments may be made without departing from the scope of the present invention.

What is claimed is:

1. An adjustable wrench comprising:
a handle with a head connected to an end thereof and a fixed jaw connected to a top of the head, a slot defined in the top of the head, a passage defined through the head and communicating with the slot;
a movable jaw having a guide rod on a bottom thereof and two rack portions defined in the guide rod, the guide rod slidably engaged with the slot, and
two pawls movably engaged with the passage and each pawl having teeth defined in a top surface thereof, the teeth of the two pawls being alternatively engaged with the two rack portions, two respective positioning units located between the two pawls and an inside of the passage so as to position the pawls to be engaged with the pawls or separated from the pawls.

2. The wrench as claimed in claim 1, wherein two respective operation pads are connected to the two pawls and located on two sides of the head.

3. The wrench as claimed in claim 2, wherein a retaining frame and an insertion are located between each pawl and each operation pad respectively, each of the retaining frames has a notch and each of the insertion has a catch which is engaged with the notch.

4. The wrench as claimed in claim 3, wherein each of the pawls has one of the retaining frame connected thereto and each of the operation pads has one of the insertions connected thereto.

5. The wrench as claimed in claim 3, wherein each of the retaining frames is connected to one of two plates and each plate has protrusions, each of the pawls has oval holes with which the protrusions are engaged.

6. The wrench as claimed in claim 1, wherein a spring is biased between an underside of each of the two pawls and another inside of the passage.

7. The wrench as claimed in claim 6, wherein each of the pawls has a bottom hole defined in the underside thereof so as to receive on end of the spring.

8. The wrench as claimed in claim 1, wherein a first groove and a second groove are defined in the inside of the passage and the positioning units are engaged with one of the first and second grooves.

9. The wrench as claimed in claim 8, wherein each of the pawls includes a side hole and the two positioning units each comprise a spring and a bead which is biased by the spring which is engaged with the side hole, the bead is optionally engaged with one of the first and second grooves.

10. The wrench as claimed in claim 8, wherein the first groove has a distance extending in axial direction of the head and the positioning unit is movable within the distance when the movable jaw moves along the slot.

11. The wrench as claimed in claim 3, wherein two respective covers are located between the pawls and the operation pads, each cover has a guide hole defined therethrough so that the retaining frame and the insertion are movable within the guide hole, the two covers are engaged with two recessed areas defined in the two sides of the head.

12. The wrench as claimed in claim 1, wherein the two rack portions are located on a lower portion of the guide rod.
